(19) United States
(12) Patent Application Publication
(10) Pub. No.: US 2010/0278708 A1
(43) Pub. Date: Nov. 4, 2010

(54) PROCEDURES FOR AMMONIA PRODUCTION

(75) Inventors: Gerard Sean McGrady, Lincoln (CA); Christopher Willson, Fredericton (CA)

Correspondence Address: Milstein Zhang & Wu LLC, 49 Lexington Street, Suite 6, Newton, MA, 02465-1062, US

(73) Assignee: HSM SYSTEMS, INC., FREDERICTON, NB (CA)

(21) Appl. No.: 12/664,054

(22) PCT Filed: Jun. 12, 2008
(86) PCT No.: PCT/US2008/066638

§ 371 Date: Jul. 22, 2010

Related U.S. Application Data
(60) Provisional application No. 60/943,443, filed on Jun. 12, 2007.

(51) Int. Cl. C01C 1/04

(52) U.S. Cl. 423/363; 423/359; 423/362

(57) ABSTRACT

The invention provides systems and methods for producing ammonia under conditions having at least one of a temperature and a pressure that are respectively lower than the temperature and pressure at which the Haber process is performed. In some embodiments, a supercritical fluid is used as a reaction medium.

### CROSS-REFERENCE TO RELATED APPLICATIONS

This application claims priority to and the benefit of co-pending U.S. provisional patent application Ser. No. 60/943,443, filed Jun. 12, 2007, which application is incorporated herein by reference in its entirety.

### FIELD OF THE INVENTION

The invention relates to systems and methods for performing chemical processing and production in general and particularly to systems and methods that employ metal nitrides in the production of ammonia and its derivatives.

### BACKGROUND OF THE INVENTION

The Haber process (also known as the Haber-Bosch process and Fritz Haber process) is the reaction of nitrogen and hydrogen to produce ammonia. The nitrogen (N₂) and hydrogen (H₂) gases are reacted, usually over an iron catalyst (Fe³⁺). The reaction is carried out under conditions of 250 atmospheres (bar) and temperatures of 450-500° C.; resulting in a yield of 10-20% NH₃ according to the reaction described by Eq. 1.

N₂(g)+3H₂(g) [symbol] 2NH₃(g) ΔH=−92.4 kJ mol⁻¹ Eq. 1

The reaction is reversible, meaning the reaction can proceed in either the forward or the reverse direction depending on conditions. The forward reaction is exothermic, meaning it produces heat and is favored at low temperatures, according to Le Chatelier's Principle. Increasing the temperature tends to drive the reaction in the reverse direction, which is undesirable if the goal is to produce ammonia. However, reducing the temperature reduces the rate of the reaction, which is also undesirable. Therefore, an intermediate temperature high enough to allow the reaction to proceed at a reasonable rate, yet not so high as to drive the reaction in the reverse direction, is required. Usually, 450° C. is used.

High pressures favor the forward reaction because there are 4 moles of reactant for every 2 moles of product, meaning the position of the equilibrium will shift to the right to produce more ammonia. So the only compromise in pressure is the economical situation trying to increase the pressure as much as possible. Usually, a pressure of around 200 bar is used.

The catalyst has no effect on the position of equilibrium; rather does it alter the reaction pathway, reducing the activation energy of system and hence in turn increase the reaction rate. This allows the process to be operated at lower temperatures, which as mentioned before favors the forward reaction. However, the advantage that would be gained by finding an improved catalyst or a procedure for operating at a lower temperature is borne out by considering the temperature dependence of the equilibrium constant for the reaction, detailed in Table 1 below.

TABLE 1
Temperature-dependence of the equilibrium constant,
K_{eq}, for the synthesis of NH₃ from N₂ and H₂.

| T/° C. | 25 | 200 | 300 | 400 | 500 |
|---|---|---|---|---|---|
| K_{eq} | 6.4 × 10² | 4.4 × 10¹ | 4.3 × 10⁻³ | 1.6 × 10⁻⁴ | 1.5 × 10⁻⁵ |

The ammonia is formed as a gas but on cooling in the condenser liquefies at the high pressures used, and so is removed as a liquid. Unreacted nitrogen and hydrogen are then fed back in to the reaction.

### SUMMARY OF THE INVENTION

In one aspect, the invention relates to a process for producing ammonia in a supercritical reaction medium. The process comprises the steps of providing a reaction chamber configured to operate at temperatures and pressures sufficient to support the presence of a supercritical fluid therein; providing a reaction medium that forms a supercritical fluid when maintained above a critical temperature and a critical pressure; providing a source of hydrogen, the hydrogen in the form provided being soluble in the supercritical fluid; providing a source of nitrogen, the nitrogen in the form provided being soluble in the supercritical fluid; reacting the hydrogen and the nitrogen present in the supercritical fluid to form ammonia; and recovering the ammonia produced from the reaction chamber. The process permits one to generate ammonia under conditions having at least one of a temperature and a pressure respectively lower than the pressure and the temperature required to perform the Haber process.

In one embodiment, the process for producing ammonia in a supercritical reaction medium further comprises the step of providing a catalyst comprising a metal nitride. In one embodiment, said catalyst comprises metal a selected from the group consisting of lithium, iron, cobalt, nickel, titanium and vanadium. In one embodiment, the step of providing a catalyst comprising a metal nitride comprises providing a catalyst comprising a mixed metal nitride having a plurality of metallic elements therein.

In one embodiment, the supercritical fluid comprises ammonia. In one embodiment, the supercritical fluid comprises carbon dioxide. In one embodiment, the supercritical fluid comprises water. In one embodiment, the supercritical fluid comprises ethane. In one embodiment, the supercritical fluid comprises propane. In one embodiment, the supercritical fluid comprises sulfur hexafluoride.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 is a diagram that illustrates the pressure-temperature relations of three phases, gas, liquid, and solid for the material CO₂, including the critical point of pressure and temperature above which the liquid and gaseous states merge into a supercritical state.

FIG. 2 is a schematic diagram illustrating the features of a chemical reactor in which aspects of the invention can be practiced.

### DETAILED DESCRIPTION OF THE INVENTION

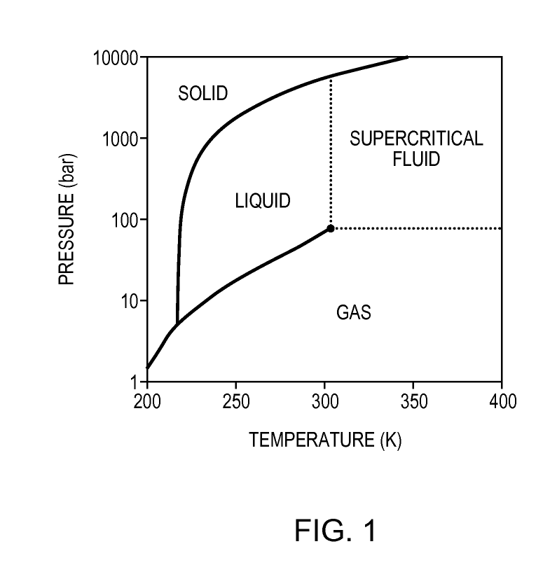

Supercritical fluids (SCFs) exist above the critical pressure and critical temperature of a material, as depicted in FIG. 1, the phase diagram for CO₂. In this regime the material enters a new phase, and the properties normally associated with gases and liquids are co-mingled. Thus the fluid can act as a solvent, at the same time remaining completely miscible with permanent gases like hydrogen. The mass- and thermal-transfer properties of a supercritical fluid offer significant advantages over conventional solid-gas or solid-solution approaches as outlined above, and these advantages have been recognized for over a decade. In fact, organic hydrogenation reactions have been carried out using supercritical fluids for several years, with some striking successes.

The total miscibility of permanent gases like H₂ and N₂ with a supercritical fluid means that very high concentrations of these gases can be attained in the medium. Furthermore, the low surface tension of the supercritical fluid allows for effective penetration of high surface area or porous solids; for example the iron catalysts described hereinabove. In addition, the high mass- and thermal-transfer characteristics of supercritical fluid are also advantageous in facilitating heterogeneous reactions or catalysis.

A preferred supercritical fluid medium for the preparation of NH₃ from H₂ and N₂ is ammonia itself. This has a critical temperature (T_{c}) of 132° C. and a critical pressure (p_{c}) of 113 bar. At temperatures and pressures above these values, NH₃ is in its supercritical phase. Supercritical fluids are generally quite convective when maintained at the requisite temperatures and pressures. Accordingly, it is expected that a catalyst comprising a solid portion of a transition metal or other catalytic substance can be made accessible to a mixture of a supercritical fluid and one or more gases dissolved therein even if the catalyst is placed to one side of the chemical reactor, for example in a side chamber that can be connected to or disconnected from the main portion of the chemical reactor by valved tubes. In this manner, a chemical reactor having a supercritical fluid with one or more reagent gases dissolved therein can be selectively exposed to the solid catalyst by the simple expedient of opening valves to allow the supercritical fluid to circulate past the solid catalyst, and can be selectively separated from the solid catalyst by the simple expedient of closing the valves, thereby shutting off the communication between the main portion of the chemical reactor and the side chamber. This may be useful for operating the chemical reactor to generate product, such as additional ammonia, at certain times, and at other time, preventing further reaction from taking place and opening the chemical reactor to remove some or all of the ammonia product.

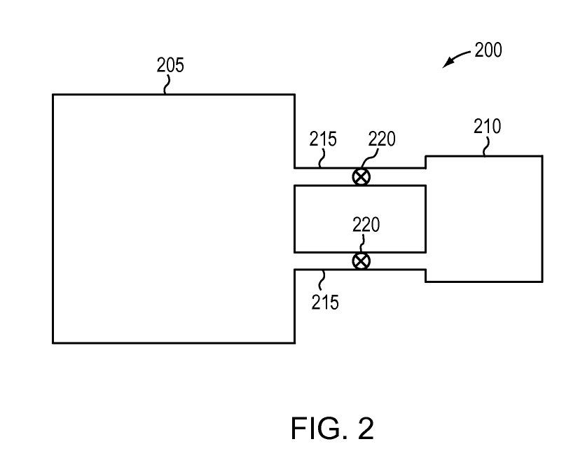

FIG. 2 is a schematic diagram illustrating the features of such a chemical reactor 200, including a main portion of the chemical reactor 205, a side chamber 210 that can contain a catalyst, tubes 215 that connect the main portion of the chemical reactor 205 and the side chamber 210, and valves 220 that allow communication via the tubes 215 when open and that shut off communication via the tubes 215 when closed. Well-known elements such as heaters, heating controllers, temperature measuring elements such as thermocouples and pyrometers, pressure valves, pressure controls and pressure measuring elements such as sensors or gauges can be added to the chemical reactors that are used in performing the chemical reactions described, and are not shown in FIG. 2 for simplicity. In many modern systems, control systems configured to operate a reactor 200 can be provided by using a general purpose computer programmed with software comprising instructions or programmed with a commercially available equipment interfacing software package such as LabView™ available from National Instruments Corporation., 11500 N Mopac Expressway, Austin, Tex. 78759-3504. The general purpose programmable computer-based control system can be operated by personnel having a basic understanding of computer-based systems, and an understanding of the nature and behavior of the chemical system and reactions that are being operated. A suitable operator of such a system might be a high school graduate with experience operating general purpose computers and the capacity to follow directions, and ranging up to a person having one or more postgraduate degrees in a technical discipline such as chemistry, chemical engineering, or materials processing.

### First Embodiment

This invention relates to the use of metal nitrides to catalyze the preparation of ammonia from hydrogen and nitrogen. There is currently a wide range of interest in lithium nitride, Li₃N, as a hydrogen storage material. This is because it reacts reversibly with hydrogen at 250° C., according to the reaction described by Eq. 2. This is further described in Langmi, H.; McGrady, G. S. Coord. Chem. Rev. 2007, 251, 925 (hereinafter “the Langmi article”).

Li₃N(s)+2H₂(g) [symbol] 2LiH(s)+LiNH₂(s) Eq. 2

The adsorbed hydrogen can be released by heating, but it desorbs along with a small amount of ammonia, which tends to poison catalysts in fuel cells.

As was explained in the Langmi article, one aspect of critical importance associated with the Li—N—H system is the possibility of generating ammonia during hydrogenation and dehydrogenation of the material. In fact, NH₃ formation is thermodynamically favorable at temperatures below 400° C. Hino et al. concluded that about 0.1% NH₃ inevitably contaminates the hydrogen desorbed from a mixture of LiH and LiNH₂ at any temperature up to 400° C. in a closed system. Ammonia also plays a mediating role in the hydrogen desorption reaction (see Eq. 2), which comprises two elementary steps:

2LiNH₂→Li₂NH+NH₃ ΔH=+84 kJ/mol Eq. 3

LiH+NH₃→LiNH₂+H₂ ΔH=−42 kJ/mol Eq. 4

Hu and Ruckenstein claimed that the reaction described by Eq. 4 is ultra-fast; NH₃ released from the reaction described by Eq. 3 is totally captured by LiH in the reaction described by Eq. 4 even when contact is only for 25 ms. As a result of the speed at which the reaction described by Eq. 4 occurs, NH₃ formation during the hydrogenation of Li₃N is suppressed and NH₃ generated during the dehydrogenation process is prevented from contaminating the H₂ gas emitted. As should be understood, a reaction that fails to provide readily extracted NH₃ that can then be purified is of little interest in the present circumstance.

Pinkerton illustrated that in a dynamic H₂ atmosphere, a slow but significant decomposition of LiNH₂ by NH₃ release occurs. Under a static gas atmosphere the formation of NH₃ is self-limiting. While some studies have detected no NH₃ during the hydrogenation/dehydrogenation of Li₃N, others have reported small amounts of NH₃ emission. As will also be understood, there will be minimal interest in a reaction that is self-limiting in the production of the desired end product.

Ichikawa et al. examined the effect of catalysts on the desorption properties of ball-milled mixtures of LiNH₂/LiH (1:1 molar ratio) with 1 mol % of various catalysts such as Fe, Co, or Ni nanoparticles, TiCl₃ and VCl₃. The desorption spectra of the ball-milled sample without catalyst addition showed that H₂ is released between 180 and 400° C. with a significant amount of NH₃ emission. The mixture containing 1 mol % TiCl₃ exhibits the best H₂ desorption properties, releasing approximately 5.5-6.0 wt. % H₂ at 150-250° C. with relatively fast kinetics and good reversibility, and no release of NH₃.

Ichikawa et al. examined the isothermal hydrogen absorption properties of a 3:8 molar mixture of Mg(NH₂)₂ and LiH. The mixture was first ball-milled and dehydrogenated at 200° C. under high vacuum. The P-C-T curve at 200° C. showed a two-plateau-like behavior and attained the fully hydrogenated state under 9 MPa H₂. Meanwhile, the P-C-T curve at 150° C. exhibited single-plateau-like behavior and only reached a partially hydrogenated state under the same H₂ pressure. Another study on a 3:8 molar mixture of Mg(NH₂)₂ and LiH showed that the mixture starts to desorb hydrogen at 140° C., recording a peak desorption at 190° C., with almost no NH₃ emission. The system was reported to have superior qualities in terms of hydrogen storage to one of LiNH₂ and LiH; it can reversibly absorb/desorb about 7.0 wt. % H₂ at moderate temperature and pressure:

3Mg(NH₂)₂+8LiH [symbol] Mg3N₂+4Li₂NH+8H₂ Eq. 5

It was later reported that the reaction described by Eq. 5 actually comprises a series of intermediate reactions mediated by NH₃. A mixture of Mg(NH₂)₂ and LiH in a molar ratio of 1:4 has also been studied. A wide range of other amide-hydride systems has been studied, including Mg(NH₂)₂ and MgH₂; LiNH₂ and MgH₂; Mg(NH₂)₂ and NaH; Ca(NH₂)₂ and CaH₂; LiNH₂ and LiBH₄; and LiNH₂ and LiAlH₄. It is noteworthy that LiNH₂ has been demonstrated to destabilize LiBH₄ and LiAlH₄; the latter two compounds are regarded as promising hydrogen storage materials because of their very high hydrogen content. In general, the temperature at which H₂ desorption occurs in amide-hydride systems is significantly lower when compared to the decomposition temperature for the corresponding pure amide and hydride.

The iron catalyst described above assists in breaking the H—H bond, allowing dissociated hydrogen to react with the much more inert N₂ molecule. This is why relatively high temperatures are still needed for the production of ammonia. While high total pressures are a thermodynamic requirement of the process, a catalyst that is able to activate both N₂ and H₂ is expected to allow the reaction to occur at significantly lower temperatures, with significant economic benefits in terms of improved yield of ammonia and lower process temperatures.

Lithium is one of the few metals that form a stable nitride containing N³⁻. Lithium metal reacts directly with nitrogen and accordingly must be handled under argon. It is expected that the properties of mixed nitrides containing lithium and a range of transition metals, such as iron, titanium, vanadium and manganese may include materials having useful catalytic properties. Such a ternary nitride will have the potential to be an active catalyst in the Haber process, reacting directly with both N₂ and H₂, and activating both components of the ammonia synthesis gas mixture. The chemical nature of the adsorbed hydride can be tuned from acidic, through neutral, to basic, by appropriate choice of transition metal, and its proximity in the structure to the amide anion (NH₂⁻) should ensure facile reaction to produce ammonia. The production of ammonia will leave a vacant nitride site in the structure (e.g., the nitrogen converted to ammonia will leave the structure), which can be filled by adsorption of N₂. It is expected that the N³⁻ thus formed will react immediately with H₂ to regenerate another amide ion, thereby completing the cycle.

### Second Embodiment

This invention relates to the use of a supercritical fluid, and in particular supercritical ammonia, as a reaction medium for the preparation of ammonia from hydrogen and nitrogen. Over the past decade, supercritical fluids have developed from laboratory curiosities to occupy an important role in synthetic chemistry and industry. Supercritical fluids combine the most desirable properties of a liquid with those of a gas: these include the ability to dissolve solids and total miscibility with permanent gases. For example, supercritical carbon dioxide has found a wide range of applications in homogeneous and heterogeneous catalysis, including such processes as hydrogenation, hydroformylation, olefin metathesis and Fischer-Tropsch synthesis. Supercritical water has also found wide utility in enhancing organic reactions.

We anticipate that the advantageous properties of supercritical fluid medium described above will permit high concentrations of H₂ and N₂ to be brought into intimate contact with an appropriate catalyst and reacted together effectively to form NH₃ at temperatures and total pressures significantly below those described for the Haber process, with significant savings in energy costs and improvements in overall yields. Use of the reaction product (NH₃) as the reaction medium also offers significant process costs in terms of subsequent separation, although many other materials may be considered as an appropriate supercritical fluid medium for carrying out the reaction described in Eq. 1. Some of these are described in Table 2 below, but this is not an exhaustive list.

TABLE 2
Salient properties of potential media for
the synthesis of NH₃ from N₂ and H₂.

| | | T_{c} | p_{c} |
|---|---|---|---|
| Compound | Formula | (° C.) | (bar) |
| Ammonia | NH₃ | 132 | 113 |
| Carbon dioxide | CO₂ | 31 | 74 |
| Ethane | C₂H₆ | 32 | 49 |
| Propane | C₃H₈ | 97 | 42 |
| Sulfur hexafluoride | SF₆ | 46 | 58 |

### THEORETICAL DISCUSSION

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

While the present invention has been particularly shown and described with reference to the structure and methods disclosed herein and as illustrated in the drawings, it is not confined to the details set forth and this invention is intended to cover any modifications and changes as may come within the scope and spirit of the following claims.

What is claimed is:

1. A process for producing ammonia in a supercritical reaction medium, comprising the steps of:
providing a reaction chamber configured to operate at temperatures and pressures sufficient to support the presence of a supercritical fluid therein;
providing a reaction medium that forms a supercritical fluid when maintained above a critical temperature and a critical pressure;
providing a source of hydrogen, the hydrogen in the form provided being soluble in the supercritical fluid;
providing a source of nitrogen, the nitrogen in the form provided being soluble in the supercritical fluid;
reacting the hydrogen and the nitrogen present in the supercritical fluid to form ammonia; and
recovering the ammonia produced from the reaction chamber;
thereby generating ammonia under conditions having at least one of a temperature and a pressure respectively lower than the pressure and the temperature required to perform the Haber process.

2. The process for producing ammonia in a supercritical reaction medium of claim 1, further comprising the step of providing a catalyst comprising a metal nitride.

3. The process for producing ammonia in a supercritical reaction medium of claim 2, wherein said catalyst comprises metal a selected from the group consisting of lithium, iron, cobalt, nickel, titanium and vanadium.

4. The process for producing ammonia in a supercritical reaction medium of claim 3, wherein the step of providing a catalyst comprising a metal nitride comprises providing a catalyst comprising a mixed metal nitride having a plurality of metallic elements therein.

5. The process for producing ammonia in a supercritical reaction medium of claim 1, wherein the supercritical fluid comprises ammonia.

6. The process for producing ammonia in a supercritical reaction medium of claim 1, wherein the supercritical fluid comprises carbon dioxide.

7. The process for producing ammonia in a supercritical reaction medium of claim 1, wherein the supercritical fluid comprises water.

8. The process for producing ammonia in a supercritical reaction medium of claim 1, wherein the supercritical fluid comprises ethane.

9. The process for producing ammonia in a supercritical reaction medium of claim 1, wherein the supercritical fluid comprises propane.

10. The process for producing ammonia in a supercritical reaction medium of claim 1, wherein the supercritical fluid comprises sulfur hexafluoride.
